(19) United States
(12) Patent Application Publication
(10) Pub. No.: US 2009/0311936 A1
(43) Pub. Date: Dec. 17, 2009

(54) MINERAL WOOL, INSULATING PRODUCT AND MANUFACTURING PROCESS

(75) Inventors: Philippe Espiard, Gouvieux (FR); Bruno Mahieuxe, Neuilly Sous Clermont (FR); Jerome Douce, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN ISOVER, COURBEVOIE (FR)

(21) Appl. No.: 12/307,287

(22) PCT Filed: Jul. 6, 2007
(86) PCT No.: PCT/FR07/51607

§ 371 Date: Jan. 2, 2009

(30) Foreign Application Priority Data
Jul. 7, 2006 (FR) 0652874

(51) Int. Cl. B32B 15/14; B05D 7/00; D04H 13/00

(52) U.S. Cl. 442/378; 427/221; 442/327

(57) ABSTRACT

One subject of the invention is a process for obtaining mineral wool comprising mineral fibres and an organic binder, in which process said mineral fibres are formed and said organic binder is added on at least part of the surface of said mineral fibres, characterized in that a compound is furthermore added to at least one part of the surface of said mineral fibres, said compound comprising at least one resin acid or resin acid derivative and also a water-repellent agent. The subject of the invention is also a mineral wool that can be obtained by this process.

The present invention relates to the field of artificial mineral wools. It relates more particularly to glass wools intended to be incorporated into thermal and/or acoustic insulation materials.

Mineral wools are capable, when certain geometric criteria in terms of diameter and/or length are observed, of being introduced by inhalation into the body and especially into the lungs, sometimes all the way to the pulmonary alveoli. To prevent any pathogenic risk linked to a possible accumulation of fibers in the body, it has become necessary to make sure that the fibers have a low “biopersistence”, that is to say that they can be easily and rapidly eliminated from the body. The chemical composition of the fibers is a major parameter influencing this ability to be rapidly eliminated from the body, as it plays a significant role in the dissolution rate of the fibers in a physiological medium. Mineral wools having high dissolution rates in a physiological medium (“biosoluble” mineral wools) have therefore been formulated and described in the prior art.

The main difficulty consists however, in increasing the dissolution rate of the fibers in a physiological medium while retaining the good working properties of the end product, especially the mechanical strength and the stability of this mechanical strength during exposure to moisture. This latter point is particularly crucial and tricky, since the two criteria of wet strength and biosolubility are in most respects contradictory, as they both relate to the ability to be dissolved in a predominantly aqueous medium.

Wet-strength requirements are becoming increasingly strict in numerous applications, in particular in the field of glass wools used for producing construction components, especially “sandwich” panels, in which the mineral wool makes up an insulating core between two metal facings (for example, steel or aluminum facings). These construction components are mainly used for roofs and roof cladding, walls and exterior wall cladding, and walls, partition walls and ceilings located inside the building envelope. Considering the multiple mechanical stresses to which they may be subjected, very good compressive, tear and shear strength properties are demanded. It is important, moreover, that the mechanical strength and especially the tear strength, of these products subjected to ambient humidity do not decline too significantly over time: this is what is understood in the remainder of the text by “resistance to aging in a humid environment”. These various requirements are, in particular, specified in the draft of standard prEN 14509 “Self-supporting double-skin metal-faced insulating sandwich panels—Factory made products—Specifications”.

The resistance to aging in a humid environment is also a strict requirement for other types of product, especially the mineral wool panels used for the insulation and impermeability of roof terraces or the external insulation of facades.

The objective of the present invention is to improve the resistance to aging in a humid environment of mineral wools capable of dissolving in a physiological medium.

For this purpose, the inventors have observed that resin acids or their derivatives had the advantage of improving the mechanical properties of mineral wools after aging in a humid environment.

It was known to add tall oil as an additive to the organic binders having the role of providing the cohesion of the fibers to one another. U.S. Pat. No. 3,932,334 mentions it, for example, in a list of additives comprising silanes, mineral fillers, viscosity-control agents, etc.

Document U.S. Pat. No. 2,584,300 itself describes a binder for mineral wool, the main component of which is a mixture of tall oil, carboxylic acid esters and polyols.

Tall oil, which is a by-product of the manufacture of paper according to the “Kraft” process, comprises, for almost half of its composition, resin acids combined with fatty acids.

Document SU 1470708 describes the manufacture of insulating coatings for pipes by injection of a mixture comprising flakes of mineral wool and a phenol-formaldehyde binder modified by rosin in xylene and an organic solvent, the latter two components then being removed by evaporation in order to cure the insulating coating. The rosin is a resin comprising, for the most part, resin acids.

The technical effect of these resin acids or their derivatives that consists in improving the mechanical properties after aging in a humid environment is not, however, described in the prior art.

One subject of the invention is therefore the use of at least one organic compound chosen from resin acids or derivatives thereof in a sufficient amount to improve the mechanical properties of mineral wools after aging in a humid environment.

The inventors have, however, observed that the compounds comprising resin acids or derivatives thereof, especially when they are in the form of an emulsion in water, had the drawback of very substantially increasing the absorption of water by the product. This phenomenon is particularly surprising since it was commonly considered until then that the properties of resistance to aging in a humid environment and of low water absorption were correlated, the products that absorb little water being intuitively capable of offering a better resistance.

Another subject of the invention is therefore a process for obtaining mineral wool comprising mineral fibers and an organic binder, in which said mineral fibers are formed and said organic binder and a compound comprising at least one resin acid or a resin acid derivative are added over at least one part of the surface of said mineral fibers, characterized in that a water-repellant agent is also added over at least one part of the surface of said mineral fibers.

Resin acids are diterpene monocarboxylic acids, generally isomers of general formula C₂₀H₃₀O₂. Their name “resin” comes from the fact that they are synthesized by plants, in particular resinous plants. Contained in their resin, they have the role of protecting plants against external attacks (insects, fungi, wounds, etc.).

Resin acids are divided into several categories depending on their basic chemical structure. Thus, structures of the following types are distinguished: abietane, pimarane/isopimarane which have three rings containing six carbons connected along one side, or else labdane. All have a carboxylic acid functionality and at least one double bond, generally two or three double bonds, including two conjugating double bonds for acids of abietane structure.

The most common resin acids are:
for the group of abietanes: abietic acid (CAS No. 514-10-3, structure of formula A below), neoabietic acid (CAS No. 471-77-2), palustric acid (CAS No. 1945-53-5), levopimaric acid (CAS No. 79-54-9) and dehydroabietic acid (CAS No. 1740-19-8); and
for the group of pimaranes: pimaric acid (CAS No. 127-27-5, structure of formula B below), isopimaric acid (CAS No. 5835-26-7) and sandaracopimaric acid (CAS No. 471-74-9).

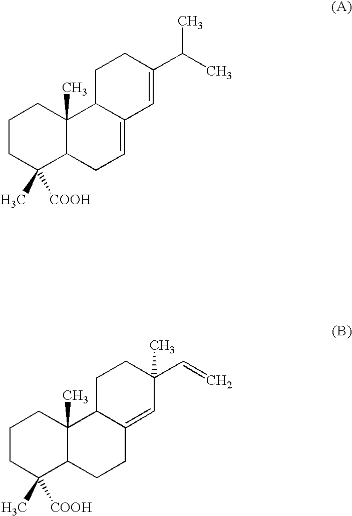

Resin acids may be obtained directly from pine oleoresin. This is because resin acids are the main non-volatile component of pine resin. After evaporation by distillation of its volatile elements (such as terpenes, for example, α-pinene), the solidified resin or rosin is composed of around 90% by weight of resin acids, predominantly abietic acid (40 to 50%).

Resin acids may also be obtained as by-products of the “Kraft” process of paper manufacture. They are then part, with fatty acids, of what is commonly known as tall oil or pine oil. Various distillations make it possible to obtain a tall oil that is more or less purified and therefore more or less rich in resin acids. Rosin may also be obtained from tall oil and then comprises a larger proportion of pimarane-type acids.

Whatever method for obtaining them is used, a mixture of resin acids is generally obtained that is difficult to separate considering the structural similarity of these compounds. For economic reasons, the compound added according to the invention is preferably a mixture of resin acids. The compound comprising at least one resin acid or a resin acid derivative is therefore advantageously chosen from tall oil, rosin, optionally chemically modified as indicated infra or a mixture thereof.

The rosin used may be produced either from tall oil (“pine oil rosin”), or directly from pine resin (“pine turpentine rosin”), or else from aged pine stumps (“wood rosin”). In the remainder of the text, the generic term rosin comprises these various types of rosin.

The tall oil used is preferably distilled and also comprises fatty acids, mainly of the oleic type.

The compound comprising at least one resin acid preferably comprises a majority of abietic acid.

The resin acid derivative used within the context of the present invention is preferably chosen from the salts or esters of resin acids, the Diels Alder addition products of resin acids with dienophil compounds, resin acid dimers, isomers and hydrogenation or dismutation products, or a mixture thereof.

One preferred source of such derivatives is a rosin that has undergone these various saponification, esterification, addition, isomerization, hydrogenation or dismutation reactions, that will be denoted by the generic term of “chemically modified rosin”. In the remainder of the text, the generic term “resin acid” or “rosin” will cover all these derivatives, unless indicated otherwise.

Various counterions may replace the hydrogen in the carboxylic group of the resin acids and thus form carboxylic acid salts: sodium, potassium, zinc, calcium or else magnesium. The resin acid salts obtained are sometimes known as resin “soaps” and may belong to rosin soaps or tall oil soaps, obtained by neutralization of the rosin or of the tall oil.

Resin acid esters or rosin esters are obtained by esterification of the carboxyl group with alcohols, usually polyols such as, for example, glycerol, pentaerythritol, ethylene glycol, diethylene glycol and propylene glycol. In the case where polyols are used, the esterification reaction may affect one or more alcohol groups.

The addition products are obtained by Diels-Alder reaction with dienophil compounds such as maleic acid, maleic anhydride, fumaric acid or esters of fumaric, acrylic or maleic acids.

Resin acids may react together under acid conditions and at high temperature to mainly form dimers, more exceptionally trimers.

Under certain conditions, resin acids may isomerize, in general by modification of the configuration of the double bonds. Resin acids that do not exist naturally may then be obtained.

Resin acids may also undergo hydrogenation reactions that have the effect of reducing the number of double bonds or dismutation reactions, by transfer of a hydrogen atom from one resin acid to another.

It is essential to add water-repellant agents to these compounds or with the sizing composition in order to limit the water uptake of the end product within the meaning of the standard NF EN 1609. This is because it has emerged that resin acids or derivatives thereof increase this water uptake via a capillary absorption phenomenon. As already mentioned, this phenomenon is particularly surprising as it was imagined up to now that an additive that improves the properties of aging in a humid environment inevitably had the property of reducing water uptake. The reverse was also considered to be obvious, namely that by reducing the uptake of water by the product it was possible to limit the effects of aging in a humid environment. It was nothing of the sort, as will be demonstrated by the examples described below.

The term “water-repellant agent” is understood within the sense of the present invention to mean any additive that makes it possible to reduce the capillary absorption of water by the product, in particular according to the test recommended by the standard NF EN 1609 or more generally by any test that consists in measuring the absorption of water after partial or complete immersion of the product.

The addition of a water-repellant agent is particularly crucial when the compound comprising resin acids is tall oil, as it appears that the presence of fatty acids considerably increases the uptake of water by the fibrous product.

Water-repellant agents of the silicone type (polysiloxanes, especially polydimethylsiloxanes or PDMS) or paraffins are particularly valued as they make it possible to obtain the best results, especially silicones. Other water-repellant agents that can be used according to the present invention comprise fluoropolymers or mineral or organic oils. The amount added is preferably between 0.01% and 1%, especially between 0.05 and 0.5%, or even 0.2% by weight of solids relative to the weight of mineral wool. The water-repellant agents are preferably added in the form of an emulsion in water.

The compound comprising at least one resin acid or a resin acid derivative is preferably added by spraying, in particular with the organic binder, said compound optionally being mixed with said organic binder before the addition step.

The compound comprising at least one resin acid or resin acid derivative is preferably added in the form of an emulsion in water or dissolved in a predominantly organic solvent (preferably completely organic, but possibly also comprising water). The predominantly organic solvent preferably comprises an alcohol such as glycerol.

The compound comprising at least one resin acid or a resin acid derivative is preferably added in a weight content between 0.1 and 5% of solids relative to the weight of mineral wool. Contents between 0.5 and 4% are preferred.

The organic binder preferably comprises a phenol-formaldehyde resin.

Another subject of the invention is a mineral wool that is soluble in a physiological medium and is capable of being obtained according to this process.

A particularly preferred fiber composition within the scope of the present invention comprises the following constituents in the ranges defined below, expressed as percentages by weight:

| | |
|---|---|
| SiO₂ | 45 to 75 |
| Al₂O₃ | 0 to 10 |
| CaO | 0 to 15 |
| MgO | 0 to 15 |
| Na₂O | 12 to 20 |
| K₂O | 0 to 10 |
| B₂O₃ | 0 to 10 |
| Fe₂O₃ | 0 to 5 |
| P₂O₅ | 0 to 3. |

Silica (SiO₂) is a glass network former component. Too large an amount makes the viscosity of the glass too high for it to be properly melted, homogenized and refined, whereas too low an amount makes the glass thermally unstable (it devitrifies too easily on cooling) and chemically unstable (too prone to attack by moisture). The silica content is advantageously greater than or equal to 50%, or 55% and even 60% and less than or equal to 70%.

Alumina (Al₂O₃) is also a network former component capable of significantly increasing the viscosity of the glass. Present in too large an amount, it also has a negative impact on the solubility in the pulmonary alveolar fluid. When its content is low, the wet strength is greatly reduced. For these various reasons, the alumina content is advantageously greater than or equal to 1% and less than or equal to 5%, especially 3%.

The alkaline-earth metal oxides, mainly lime (CaO) and magnesia (Mgo), make it possible to reduce the high-temperature viscosity of the glass and thus facilitate the processing steps for producing a glass free from gaseous or solid inclusions. By substitution relative to the alkali metal oxides, they significantly improve the wet strength of the glass, but on the other hand they favor devitrification, making the fiberizing steps difficult. The calcium oxide content is therefore advantageously greater than or equal to 51, especially 7%, and less than or equal to 10%. As for the magnesia, its content is preferably less than or equal to 10%, even 5%, and greater than or equal to 1%, or even 2%. Other alkaline-earth metal oxides such as barium oxide (BaO) or strontium oxide (SrO) may also be present in the mineral wools according to the invention. Considering their high cost, they are however advantageously not present (apart from traces stemming from inevitable impurities of the raw materials).

The alkali metal oxides, mainly sodium oxide (Na₂O) and potassium oxide (K₂O), are particularly useful for reducing the high-temperature viscosity of the glass and increasing the devitrification resistance. They prove to be detrimental however to the resistance to aging in a humid environment. The sodium oxide content is, as a consequence, preferably less than or equal to 18% and greater than or equal to 14%. The potassium oxide content is advantageously less than or equal to 5%, or 2% and even 1%, mainly for reasons linked to the availability of the raw materials.

Boron oxide (B₂O₃) is important for reducing the viscosity of the glass and improving the biosolubility of the fibers. Its presence tends, moreover, to improve the thermal insulating properties of the mineral wool, especially by lowering its thermal conductivity coefficient in its radiative component. Moreover, considering its high cost and its ability to volatilize at high temperatures, generating harmful emissions and requiring the production sites to be equipped with fume treatment plants, the boron oxide content is preferably less than or equal to 8%, especially 6%, and even 5%. A zero content is preferred in certain embodiments.

Iron oxide is limited to a content of less than 5% on account of its role in coloring the glass, but also on account of the ability of the glass to devitrify. A high iron content makes it possible to impart a very high temperature resistance to mineral wools of the “rock wool” type, but it makes fiberizing by the internal centrifugation technique difficult or even impossible in certain cases. The iron oxide content is preferably less than or equal to 3%, and even 1%.

Phosphorus oxide (P₂O₅) may advantageously be used, especially on account of its beneficial effect on the biosolubility.

The fibers according to the invention may also contain other oxides, in amounts by mass that generally do not exceed 3%, or 2% and even 19. Among these oxides are the impurities commonly introduced by the natural or artificial (for example recycled glass, called cullet) batch materials used in this type of industry (among the most common are TiO₂, MnO, BaO, etc.). Impurities such as ZrO₂ are also commonly introduced by the partial dissolution in the glass of chemical elements deriving from the refractory materials used in the construction of furnaces. Certain traces again derive from compounds employed in glass refining: in particular, the sulfur oxide SO₃ that is very commonly employed is cited. The alkaline-earth metal oxides such as BaO, SrO and/or the alkali metal oxides such as Li₂O may be voluntarily included in the fibers according to the invention. Considering their cost, it is however preferable that the fibers according to the invention do not contain them. These various oxides, on account of their low content, do not in any case play any particular functional role which may change the manner in which the fibers according to the invention respond to the problem posed.

Another subject of the invention is the thermal and/or acoustic insulation products comprising at least one mineral wool according to the invention. These may be, in particular “sandwich” type construction components, in which the mineral wool makes up an insulating core between two metal (for example steel or aluminum) facings, these possibly self-supporting components being used in the construction of internal or external walls, roofs or ceilings. For this type of application, the density of the insulation products according to the invention is preferably between 40 and 150 kg/m³, especially between 60 and 80 kg/m³ (this density does only take into account the mineral wool).

They may also be insulation products intended for:
the external insulation of facades, especially products that have densities between 60 and 100 kg/m³, such as the products described in Application EP 1 283 196; and
the insulation of flat roofs, for example roof terraces, especially on masonry or a metallic structure of steel tray type, in particular products for which the density is between 60 and 200 kg/m³, preferably between 80 and 150 kg/m³, such as the products described in Patent Applications EP 109 879, FR 2848582 or EP 1 620 367, covered with a facing in particular based on a glass veil impregnated with bitumen.

Following the example of sandwich type components, this type of product known as “heavy” products since they have a high density, greater than 40 kg/m³, must also have a high mechanical strength, as the case may be, tear strength, shear strength or compressive strength.

The advantages offered by the invention will be better appreciated through the following examples, illustrating the present invention without however limiting it.

A mass of molten glass, of which the chemical composition (expressed in percentages by weight) is presented in table 1, was obtained by a method of melting vitrifiable batch materials using, as the main energy source, electrodes immersed in the glass bath.

TABLE 1

| Oxide | wt % |
|---|---|
| SiO₂ | 65 |
| Al₂O₃ | 2 |
| Na₂O | 16 |
| K₂O | 0.8 |
| CaO | 8 |
| MgO | 2.8 |
| B₂O₃ | 4.5 |
| Fe₂O₃ | 0.2 |
| Impurities | 0.7 |

This mass of molten glass was then converted into fibers by an internal centrifugation method, using a spinner comprising a basket forming a chamber for receiving the molten glass and a peripheral band pierced by a multitude of holes. Since the spinner was rotated about a vertical axis, the molten glass was ejected under the effect of a centrifugal force and the material escaping from the holes was attenuated into filaments with the assistance of an attenuating gas stream.

A size spray ring was placed beneath the spinners so as to spread the sizing composition (the organic binder) uniformly over the glass wool that had just been formed. The sizing composition was mainly based on phenol-formaldehyde resin and urea diluted in water before being sprayed onto the fibers. Other types of sizing composition, in particular those that are formaldehyde-free, may also be used, alone or in mixtures. They may be for example:
compositions based on an epoxy resin of the glycidyl ether type and a non-volatile amine hardener (described in Application EP-A-0 369 848), which may also comprise an accelerator chosen from imidazoles, imidazolines and mixtures thereof;
compositions comprising a carboxylic polyacid and a polyol, preferably combined with a catalyst of the alkali metal salt of a phosphorus-containing organic acid type (described in Application EP-A-0 990 727);
compositions comprising one or more compounds incorporating a carboxylic functional group and/or a β-hydroxyalkylamide functional group (described in Application WO-A-93/36368);
compositions incorporating either a carboxylic acid and an alkanolamine, or a resin previously synthesized from a carboxylic acid and from an alkanolamine, and a polymer containing a carboxylic acid group (described in Application EP-A-1 164 163);
sizing compositions prepared in two steps consisting in mixing an anhydride and an amine under reactive conditions until the anhydride is substantially dissolved in the amine and/or has reacted with it, then in adding water and terminating the reaction (described in Application EP-A-1 170 265);
compositions containing a resin that comprises the polymer-free reaction product of an amine with a first anhydride and a second anhydride that is different from the first (described in Application EP-A-1 086 932);
compositions containing at least one polycarboxylic acid and at least one polyamine;
compositions comprising copolymers of carboxylic acid and of monomers containing alcohol functional groups such as described in Application US 2005/038193; and
compositions comprising polyols and polyacids or polyanhydrides such as maleic acid, described for example in Application WO 2005/87837 or in U.S. Pat. No. 6,706,808.

Aminoplast type resins (melamine-formaldehyde or urea-formaldehyde) may also be used within the scope of the invention.

The compound comprising resin acids or derivatives thereof was added to the sizing composition (organic binder), but it may also be sprayed independently, using a second spray ring for example. The various compounds used in the examples were the following:
aqueous emulsions comprising resin acids or resin acid derivatives sold by DRT under the respective names Dermulsene RA405 (compound C1, chemically modified rosin), HBR70 (compound C2, based on rosin and on petroleum resin), DEG (compound C3, based on rosin ester and polyethylene glycol), 222 (compound C4, based on rosin ester and terpene resin), RE802 (compound C5, based on rosin ester);
an aqueous emulsion comprising fatty acids and resin acids obtained by distillation of the tall oil sold under the name Resinoline BD2 (compound C6) by DRT.

In the examples according to the invention, a water-repellant agent is added, in particular:
silicones of the DC1581 type sold by Dow Corning (aqueous emulsion of polydimethylsiloxane); or
paraffins (in the form of an aqueous emulsion) sold under the trademark Pekophob P60 by Clariant.

The mineral wool thus sized was collected on a conveyer belt equipped with internal suction boxes which made it possible to keep the mineral wool in the form of a felt or a sheet on the surface of the conveyer. The conveyer then passed through an oven where the polycondensation of the resin of the size took place. Depending on the tests, the insulating product manufactured was a panel with a density of around 80 kg/m³ (Table 2) or 65 kg/m³ (Table 3).

Sandwich panels comprising such a mineral wool were subjected to the tear strength test after aging in a humid environment described in the draft of standard prEN 14509 “Self-supporting double-skin metal-faced insulating sandwich panels—Factory made products—Specifications”. The sandwich panels were placed in an environmental chamber at 65° C. and 100% relative humidity for 28 days, the loss of tear strength after aging then being measured. In the context of the standard, a loss of less than or equal to 60% is considered satisfactory. Tables 2 and 3 describe the results, expressed in terms of loss (in percent) of tear strength.

The mineral wool produced was also subjected to the water absorption test after partial immersion as described in the standard NF EN 1609. This test simulates the absorption of water caused by rain for 24 hours during construction works. The absorption of water, known as “water uptake” in the tables is expressed in kg/m². A value of 1 kg/m² or less is considered to be satisfactory.

Indicated in these tables are, besides the nature of the compound comprising the resin acids or the derivatives used, its weight content of solids relative to the weight of the mineral wool, and where appropriate the nature and weight content of the water-repellant agent, still as solids.

TABLE 2

| | | | Water- | Loss | Water |
|---|---|---|---|---|---|
| | | | repellant | after | uptake |
| Ex. | Compound | Content | agent | aging (%) | (kg/m²) |
| 1 | None | | | 85% | 1.0 |
| 2 | C1 | 1% | | 42% | 5.0 |
| 3 | C1 | 1% | 0.1% silicones | 43% | 1.3 |
| 4 | C4 | 1% | | 54% | 6.5 |
| 5 | C5 | 1% | | 64% | 5.5 |
| 6 | C6 | 1% | 0.1% silicones | 37% | |

TABLE 3

| | | | Water- | Loss | Water |
|---|---|---|---|---|---|
| | | | repellant | after | uptake |
| | Compound | Content | agent | aging (%) | (kg/m²) |
| 1 | None | | | 82% | 1.0 |
| 7 | C1 | 3% | 0.3% silicones | 55% | 1.1 |
| 8 | C1 | 3% | 0.3% paraffins | 56% | 2.5 |
| 9 | C1 | 3% | 0.6% paraffins | 55% | 1.7 |
| 10 | C1 | 3% | 0.9% paraffins | 57% | 0.8 |
| 11 | C2 | 3% | 0.3% silicones | 59% | 1.1 |
| 12 | C2 | 3% | 0.3% paraffins | 60% | 3.3 |
| 13 | C2 | 3% | 0.6% paraffins | 60% | |
| 14 | C3 | 3% | 0.3% silicones | 59% | |

The use of resin acids or of derivatives of such acids therefore makes it possible to considerably improve the resistance of mineral wools to aging in a humid environment, and, in particular for “sandwich” type applications, to comply, in most cases, with the requirements of the draft of standard prEN 14509.

The comparison between the comparative example 1 and the examples 2, 4 and 5 shows that the addition of resin acids or of resin acid derivatives however considerably increases the uptake of water by the product, multiplying it by a factor of at least 5.

The addition of water-repellant agents, in particular silicones, makes it possible to return to water-absorption values close to 1 kg/m², or even less. This addition does not however modify the properties of resistance to aging in a humid environment.

These two results are particularly surprising since they demonstrate that the two properties, water uptake on the one hand and resistance to aging in a humid environment on the other hand, are completely uncorrelated.

1: A process for obtaining mineral wool comprising mineral fibers and an organic binder, in which said mineral fibers are formed and said organic binder and a compound comprising at least one resin acid or a resin acid derivative are added over at least one part of the surface of said mineral fibers, characterized in that a water repellant agent is also added over at least one part of the surface of said mineral fibers.

2: The process as claimed in the preceding claim, in which the compound comprising at least one resin acid or a resin acid derivative is added by spraying.

3: The process as claimed in claim 1, in which the compound comprising at least one resin acid or a resin acid derivative is added with the organic binder, said compound optionally being mixed with said organic binder before the addition step.

4: The process as claimed in claim 1, such that the compound comprising at least one resin acid or resin acid derivative is added in the form of an emulsion in water or dissolved in a predominantly organic solvent.

5: The process as claimed in claim 1, such that the compound comprising at least one resin acid or resin acid derivative is chosen from tall oil, rosin, or chemically modified rosin or a mixture thereof.

6: The process as claimed in claim 1, in which the compound added comprises at least one resin acid derivative chosen from the salts or esters of resin acids, the Diels Alder addition products of resin acids with dienophil compounds, resin acid dimers, isomers and hydrogenation or dismutation products.

7: The process as claimed in claim 1, in which the water-repellant agent is chosen from silicones, paraffin, fluoropolymers and mineral or organic oils.

8: The process as claimed in claim 1, such that the compound comprising at least one resin acid or a resin acid derivative is added in a weight content between 0.1 and 5% of solids relative to the weight of mineral wool.

9: The process as claimed in claim 1, such that the organic binder comprises a phenol-formaldehyde resin.

10: A mineral wool capable of being obtained by the process as claimed in claim 1.

11: The mineral wool as claimed in the preceding claim, the fibers of which have a chemical composition comprising the following constituents, in the ranges defined below, expressed as percentages by weight:

| | |
|---|---|
| SiO₂ | 35 to 75; |
| AL₂O₃ | 0 to 12; |
| CaO | 0 to 30; |
| MgO | 0 to 20; |
| Na₂O | 0 to 20; |
| K₂O | 0 to 10; |
| B₂O₃ | 0 to 10; |
| Fe₂O₃ | 0 to 5; and |
| P₂O₅ | 0 to 3. |

12. A thermal and/or acoustic insulation product comprising at least one mineral wool as claimed in claim 10.

13: The insulation product as claimed in the preceding claim, intended for the external insulation of facades and having a density of between 60 and 100 kg/m³ or intended for the insulation of flat roofs and having a density between 60 and 200 kg/m³, especially between 80 and 150 kg/m³.

14: A “sandwich” type construction component comprising mineral wool as claimed in claim 10 as an insulating core between two metal facings.

15: The process as claimed in claim 4, wherein said organic solvent comprises an alcohol.

16: The process as claimed in claim 15, wherein said alcohol is glycerol.
